(19) United States
(12) Patent Application Publication
(10) Pub. No.: US 2022/0031560 A1
(43) Pub. Date: Feb. 3, 2022

(54) BACK MASSAGING DEVICE AND ITS CONTROLLING METHOD OF MASSAGE ROUTE

(71) Applicant: MASALIFE CO., Ltd., Taipei City (TW)

(72) Inventor: Ka-Hong CHIU, New Taipei City (TW)

(21) Appl. No.: 17/443,495

(22) Filed: Jul. 27, 2021

(30) Foreign Application Priority Data
Jul. 31, 2020 (TW) 109126115

(51) Int. Cl. A61H 15/00

(52) U.S. Cl. CPC A61H 15/0078; A61H 2015/0014; A61H 2201/5023; A61H 2201/0149; A61H 2201/0107

(57) ABSTRACT

A back massaging device includes a seat back, a linear rack gear, a frame body, a main gear, a massage member, two motor assemblies and a control unit. The linear rack gear and the frame body are on the seat back. The main gear is pivoted at the frame body through a gear shaft. One of the motor assemblies is meshed with the main gear for rotating a massage protrusion of the massage member by an angle. Another motor assembly is meshed with the linear rack gear for driving the massage protrusion to vertically move. The control unit is electrically connected to the motor assemblies for calculating rotation angle values and vertical movements of the massage protrusion, and controlling the motor assemblies to operate synchronously to outline a trajectory pattern corresponding to one of trajectory scripts by the massage protrusion.

### RELATED APPLICATIONS

This application claims priority to Taiwan Application Serial Number 109126115, filed on Jul. 31, 2021, which is herein incorporated by reference.

### BACKGROUND

### Field of Disclosure

The present disclosure relates to a massaging device. More particularly, the present disclosure relates to a back massaging device and its controlling method of massage route.

### Description of Related Art

As people's requirements for the quality of life are getting higher and higher, a quite number of people use massage chairs to relief fatigue and promote blood circulation. Therefore, designs for massage chairs with better massage effects and experience will continue to be introduced on the market.

However, since massage protrusions of a traditional massage chair for massage operation are only driven along a monotonous and fixed movement path, it cannot meet the instant and diverse massage needs.

### SUMMARY

One aspect of the present disclosure is to provide a back massaging device and its controlling method of massage route, so as to solve the aforementioned problems of the prior art.

In one embodiment of the present disclosure, a back massaging device includes a seat back, a linear rack gear, a frame body, a gear shaft, at least one main gear, a massage member, a first motor assembly, a second motor assembly and a control unit. The seat back has a back rest portion for supporting a human back. The linear rack gear is fixedly disposed on the seat back and extends in a vertical direction of the seat back. The frame body is slidably disposed on the seat back. The gear shaft has a first rotation axis passing through the back rest portion. The main gear is pivotally disposed at one surface of the frame body through the gear shaft. The massage member includes a support arm and a massage protrusion. The support arm is fixedly connected to the massage protrusion and the gear shaft, and the massage protrusion is deviated from the first rotation axis of the gear shaft. The first motor assembly is directly or indirectly meshed with the main gear for driving the main gear to rotate about the first rotation axis so as to rotate the massage protrusion by a predetermined angle. The second motor assembly is directly or indirectly meshed with the linear rack gear for driving the frame body to vertically move along the vertical direction so as to control a height position of the massage protrusion. The control unit is disposed on the frame body, and electrically connected to the first motor assembly and the second motor assembly. When one of trajectory scripts is executed, the control unit sequentially calculates out rotation angle values and vertical movements of the massage protrusion instructed to be moved, and controls the first motor assembly and the second motor assembly to operate synchronously, so that the massage protrusion is allowed to outline a trajectory pattern corresponding to the one of the trajectory scripts.

In one or more embodiments of the present disclosure, the back massaging device further includes a first detection module, a second detection module and a conversion circuit. The first detection module is directly or indirectly meshed with the first motor assembly for detecting a first rotation angle which the first motor assembly actually performs. The second detection module is directly or indirectly meshed with the second motor assembly for detecting a second rotation angle which the second motor assembly actually performs. The conversion circuit is electrically connected to the control unit, the first detection module and the second detection module. The control unit converts the first rotation angle and the second rotation angle into a coordinate of a current position of the massage protrusion.

In one or more embodiments of the present disclosure, the first detection module includes a first linkage gear and a first detecting element, the first linkage gear is rotatably disposed on the frame body, and directly meshed with the main gear, the first detecting element is disposed on the conversion circuit, and coupled with the first linkage gear for detecting the first rotation angle which the first linkage gear is actually rotated. The second detection module includes a second linkage gear and a second detecting element. The second linkage gear is rotatably disposed on the frame body, and indirectly meshed with the second motor assembly. The second detecting element is disposed on the conversion circuit, and coupled with the second linkage gear for detecting the second rotation angle which the second linkage gear is actually rotated.

In one or more embodiments of the present disclosure, the back massaging device further includes a first speed-changing gear. The first speed-changing gear includes a large gear and a small gear which are superimposed on each other. The large gear is coaxially fixedly connected to the small gear, and meshed with the first motor assembly, the small gear that is meshed with the main gear. The first speed-changing gear is provided with a second rotation axis that is parallel to the first rotation axis.

In one or more embodiments of the present disclosure, the first motor assembly includes a first motor main body and a first threaded shaft. The first motor main body is provided with a first transmission shaft having a long axis direction that is orthogonal to the second rotation axis. The first threaded shaft is coaxially sleeved on the first transmission shaft, and meshed with the first speed-changing gear for rotating the main gear around the second rotation axis through the first speed-changing gear.

In one or more embodiments of the present disclosure, the back massaging device further includes a second speed-changing gear. The second speed-changing gear includes a large gear and a small gear which are superimposed on each other. The large gear is coaxially fixedly connected to the small gear, and meshed with the second motor assembly. The small gear is meshed with the linear rack gear. The second speed-changing gear is provided with a third rotation axis that is parallel to the first rotation axis.

In one or more embodiments of the present disclosure, the second motor assembly includes a second motor main body and a second threaded shaft. The second motor main body is provided with a second transmission shaft. The second threaded shaft is coaxially sleeved on the second transmission shaft, and meshed with the large gear for rotating the second speed-changing gear around the third rotation axis to vertically move the frame body.

In one or more embodiments of the present disclosure, the control unit is a pulse width modulation (PWM) controller.

In one or more embodiments of the present disclosure, the back massaging device further includes a plurality of rollers. The rollers are spaced distributed on one surface of the frame body facing away from the main gear, arranged between the seat back and the frame body, and pivotally connected to the frame body respectively for the frame body to be slidable on the seat back.

In one or more embodiments of the present disclosure, the back massaging device further includes a manual control device. The manual control device is disposed out of the seat back, electrically connected to the control unit, and provided with an analog direction control interface thereon. Thus, when the analog direction control interface is manipulated to send one of direction commands to the control unit during the trajectory pattern being continuously outlined by the massage protrusion, the control unit instantly drives the massage protrusion to move according to the one of the direction commands.

In one or more embodiments of the present disclosure, the manual control device includes a memory unit. The memory unit is electrically connected to the control unit, and configured to store the trajectory scripts and the direction commands.

In one or more embodiments of the present disclosure, the manual control device includes a massage-strength control interface. The massage-strength control interface is electrically connected to the control unit. Thus, when the massage-strength control interface is manipulated to send one of strength control commands to the control unit during the trajectory pattern being continuously outlined by the massage protrusion, the control unit synchronously adjusts output voltages on the first motor assembly for controlling at least one of moving speed and massage strength of the massage protrusion according to the one of strength control commands.

In one or more embodiments of the present disclosure, the control unit adjusts and outputs at least one of kinds of voltages to the first motor assembly continuously and intermittently, so that the massage protrusion is allowed to exert different massage strengths at the same moving speed.

In one or more embodiments of the present disclosure, the trajectory pattern continuously outlined by the massage protrusion is a straight line that is orthogonal to the vertical direction.

In one or more embodiments of the present disclosure, the back massaging device of claim 1 further includes a memory unit. The memory unit is disposed on the frame body, electrically connected to the control unit, and configured to store the trajectory scripts.

In one embodiment of the present disclosure, a controlling method of massage route implemented to the back massaging device, and the controlling method includes steps as followings. One of trajectory scripts is obtained and each of the trajectory scripts respectively represents a trajectory pattern continuously composed of pause point locations. Coordinate values of the pause point locations of the trajectory script are respectively analyzed out. Rotation angles and vertical movements of the massage protrusion instructed to be moved are respectively calculated according to the coordinate values of the pause point locations when the massage protrusion is moved from each of the pause locations to the next one of the pause locations. The first motor assembly and the second motor assembly are controlled to operate synchronously according to the rotation angles and the vertical movements so that the massage protrusion is allowed to pass by all of the pause point locations sequentially to continuously outline the trajectory pattern corresponding to the trajectory script within a period of time.

In one or more embodiments of the present disclosure, the massage protrusion being moved from each of the pause locations to the next one of the pause locations during the trajectory pattern being continuously outlined by the massage protrusion further includes steps as follows. Rotation angles which the first motor assembly and the second motor assembly respectively actually perform are detected, and the rotation angles are converted into a coordinate of a current position of the massage protrusion according to the rotation angles. Another rotation angle and another vertical movement of the massage protrusion instructed to move from each of the pause locations to the next one of the pause locations are respectively calculated according to the coordinate of the current position of the massage protrusion. The first motor assembly is operated to rotate the massage protrusion and the second motor assembly is operated to vertical move the massage protrusion, synchronously according to the another rotation angle and the another vertical movement, so that the massage protrusion is arrived at the next one of the pause locations.

In one or more embodiments of the present disclosure, when one of direction commands is received during the trajectory pattern being continuously outlined within the period of time by the massage protrusion, the massage protrusion is instantly moved from the trajectory pattern according to the one of direction commands.

In one or more embodiments of the present disclosure, when one of strength control commands is received during the trajectory pattern being continuously outlined within the period of time by the massage protrusion, output voltages on the first motor assembly is synchronously adjusted according to the one of the strength control commands for controlling at least one of moving speed and massage strength of the massage protrusion.

In one or more embodiments of the present disclosure, the step of the output voltages on the first motor assembly synchronously adjusted according to the one of the strength control commands further steps as follows. At least one of kinds of voltages to the first motor assembly is adjusted continuously and intermittently, so that the massage protrusion is allowed to exert different massage strengths at the same moving speed.

Thus, through the construction of the embodiments above, the present disclosure not only provides a highly flexible massage path, but also avoids monotonous and fixed trajectory patterns, and also allows to customize massage requirements.

The above description is merely used for illustrating the problems to be resolved, the technical methods for resolving the problems and their efficacies, etc. The specific details of the present disclosure will be explained in the embodiments below and related drawings.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain the principles of the present disclosure.

FIG. 1 is a front view of a back massaging device according to one embodiment of the present disclosure.

FIG. 2 is an assembling view of the back massaging device of FIG. 1 being seen through a back rest portion.

FIG. 3 is a partially disassembling view of the back massaging device of FIG. 1.

FIG. 4 is a back view of the back massaging device of FIG. 1 being seen through the back rest portion.

FIG. 5 is a front view of a manual control device of a back massaging device according to one embodiment of the present disclosure.

FIG. 6 is a flow chart of a controlling method of massage route according to one embodiment of the present disclosure.

FIG. 7 is a detailed flow chart of step 64 in FIG. 6.

FIG. 8A to FIG. 8E are continual operational schematic views of a massage member of FIG. 1 which has completed an S typed trajectory pattern.

FIG. 9A to FIG. 9E are continual operational schematic views of a massage member of FIG. 1 which has completed a linear trajectory pattern.

### DESCRIPTION OF THE EMBODIMENTS

Reference will now be made in detail to the present embodiments of the present disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present disclosure without departing from the scope or spirit of the present disclosure.

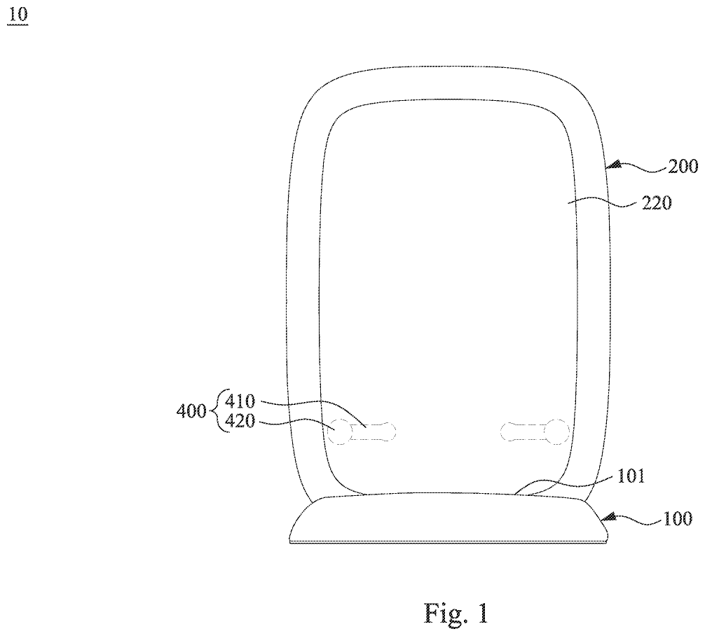

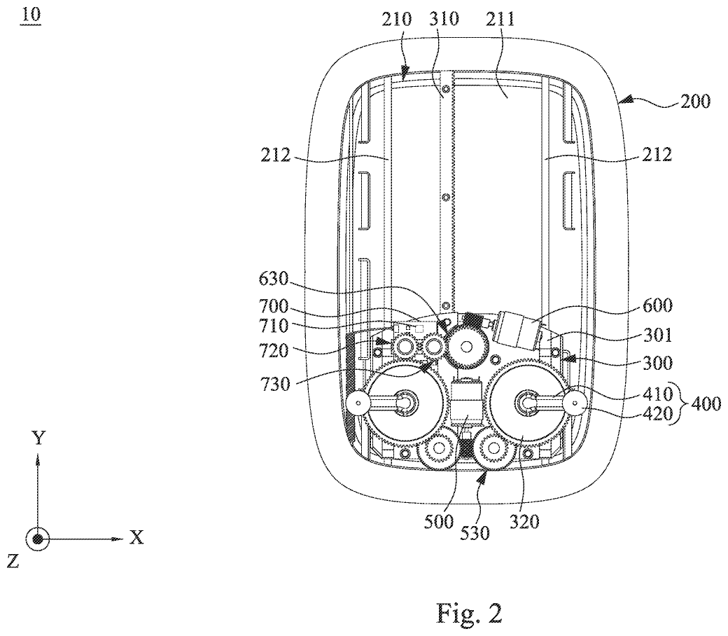

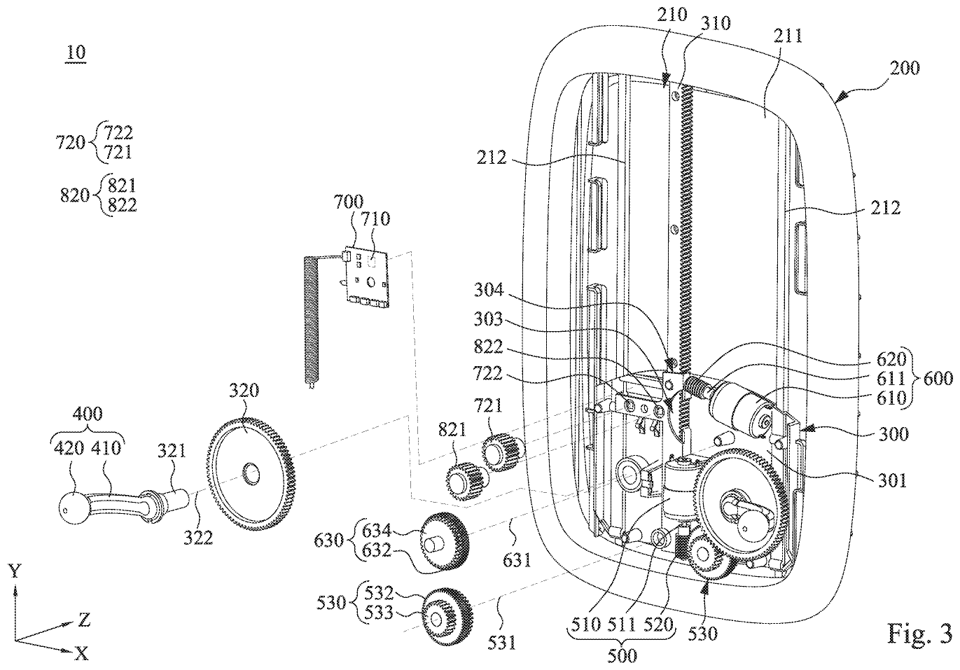

Reference is now made to FIG. 1 to FIG. 3, in which FIG. 1 is a front view of a back massaging device according to one embodiment of the present disclosure, FIG. 2 is an assembling view of the back massaging device of FIG. 1 being seen through a back rest portion 220, and FIG. 3 is a partially disassembling view of the back massaging device of FIG. 1. As shown in FIG. 1 to FIG. 3, the back massaging device 10 includes a seat 100, a seat back 200, a frame body 300, a linear rack gear 310, two main gears 320, two massage members 400, a first motor assembly 500, a second motor assembly 600 and a control unit 710.

The seat 100 is provided with a sitting portion 101 for a human body to sit on. The seat back 200 is formed with an accommodating recess 210 and a back rest portion 220. The back rest portion 220 covers the accommodating recess 210 for supporting a human back. The linear rack gear 310 is located within the accommodating recess 210, and fixedly disposed on the seat back 200 (i.e., the inner walls 211 of the accommodating recess 210). A long axis direction of the linear rack gear 310 is parallel to the vertical direction (e.g., Y-axis direction) of the seat back 200, that is, the linear rack gear 310 extends towards the vertical direction (e.g., Y-axis direction) of the seat back 200. The frame body 300 is slidably disposed on the seat back 200. The main gears 320 are arranged on one surface (refer to as a front surface 301 hereinafter) of the frame body 300 facing towards the back rest portion 220 along the X-axis direction, and symmetrically located on the front surface 301 of the frame body 300, respectively. Each of the main gears 320 is pivotally disposed at the front surface 301 of the frame body 300 through a gear shaft 321, and the gear shaft 321 has a first rotation axis 322 passing through the back rest portion 220 along the Z-axis direction.

Each of the massage members 400 includes a support arm 410 and a massage protrusion 420. One end of the support arm 410 is fixedly connected to the massage protrusion 420, and the other end of the support arm 410 is fixedly connected to the gear shaft 321, and fixedly connected to the corresponding one of the main gears 320 through the gear shaft 321. The massage protrusion 420 is deviated from the first rotation axis 322 of the gear shaft 321. In other words, the massage protrusion 420 is not coaxial with the first rotation axis 322, and is located away from the first rotation axis 322. The massage protrusion 420 is used to massage the back of the human body through the back rest portion 220. For example, the support arm 410 is shaped as a curved arc shape, and the massage protrusion 420 is shaped in a spherical shape. However, the disclosure is not limited to this.

The first motor assembly 500 is fixedly connected to the front surface 301 of the frame body 300, and the first motor assembly 500 is indirectly meshed (or engaged) with the main gears 320 through at least one toothed linkage component (e.g., intermediated gears) for driving the main gears 320 to rotate about the first rotation axis 322 so as to rotate the massage protrusion 420 by a predetermined angle. The second motor assembly 600 is fixedly connected to the front surface 301 of the frame body 300, and indirectly meshed with the linear rack gear 310 through the corresponding toothed linkage component (e.g., intermediated gears) for driving the frame body 300 to vertically move up or down along the vertical direction (e.g., Y-axis direction) so as to control a height position of the massage protrusion 420. However, the disclosure is not limited to thereto. In other embodiments, the first motor assembly 500 can also be directly meshed with the main gears 320, and the second motor assembly 600 can also be directly meshed with the linear rack gear 310.

The control unit 710 is disposed on the frame body 300 (e.g., a printed circuit board 700), and electrically connected to the first motor assembly 500 and the second motor assembly 600. The control unit 710 is used to (1) obtain one of trajectory scripts representing a trajectory pattern continuously composed of pause point locations, (2) analyze out coordinate values of the pause point locations of the trajectory script, (3) calculate rotation angles and vertical movements of the massage protrusion that is instructed to be moved according to the coordinate values of the pause point locations, (4) control the first motor assembly 500 and the second motor assembly 600 to operate synchronously according to the rotation angles and the vertical movements so that each of the massage protrusions 420 is allowed to continuously outline the trajectory pattern corresponding to the trajectory script within a period of time.

It is noted, the trajectory pattern means a trajectory path indicated by the continuous movement of each of the massage protrusions 420 on the back of the human body through the back rest portion 220, and each of the trajectory scripts provides a different trajectory pattern.

For example, the control unit 710 is a pulse width modulation (PWM) controller. The control unit 710 is disposed on the printed circuit board 700 of the frame body 300, and electrically connected to a memory unit (not shown) mounted on the printed circuit board 700 so that the control unit 710 can select one of the trajectory scripts stored in the memory unit. Thus, different from the traditional simple switch motor control, the PWM controller can control the motor voltage per 0.01 second and divides 256 kinds of voltage changes in a range from 0% to 100%). However, the disclosure is not limited to the types of the control unit 710.

More specifically, the back massaging device 10 further includes a first detection module 720, a second detection module 730 and a conversion circuit (not shown in figures). The first detection module 720 is indirectly meshed with the first motor assembly 500 through at least one toothed linkage component (e.g., intermediated gears) for detecting a first rotation angle which the first motor assembly 500 actually performs. The second detection module 730 is indirectly meshed with the second motor assembly 600 through the corresponding toothed linkage component (e.g., intermediated gears) for detecting a second rotation angle which the second motor assembly actually performs. The conversion circuit is disposed on the printed circuit board 700, electrically connected to the control unit 710, the first detection module 720 and the second detection module 730 for assisting the control unit 710 to convert the first rotation angle and the second rotation angle into a coordinate of a current position of the massage protrusion 420.

For example, the first detection module 720 includes a first linkage gear 721 and a first detecting element 722. The first linkage gear 721 is rotatably disposed on the frame body 300, and indirectly meshed with the first motor assembly 500 through the corresponding toothed linkage component (e.g., intermediated gears). The first detecting element 722 is disposed on the conversion circuit, and coupled to the first linkage gear 721 for detecting a rotation angle which the first linkage gear 721 is actually rotated. In the embodiment, the first detecting element 722 is rotatably disposed inside a pivot of the first linkage gear 721. The second detection module 730 includes a second linkage gear 731 and a second detecting element 732. The second linkage gear 731 is rotatably disposed on the frame body 300, and indirectly meshed with the second motor assembly 600 through the corresponding toothed linkage component (e.g., intermediated gears). The second detecting element 732 is disposed on the conversion circuit, and coupled with the second linkage gear 731 through the corresponding toothed linkage component (e.g., intermediated gears) for detecting the second rotation angle which the second linkage gear is actually rotated. In the embodiment, the second detecting element 732 is rotatably disposed inside a pivot of the second linkage gear 731.

In addition, the first detecting element 722 and the second detecting element 732 are respectively, for example, a hall sensor chip, for providing a precise position sensing function. However, the disclosure is not limited to this. In the embodiment, the first detecting element 722 and the second detecting element 732 may also be various motor encoders.

Furthermore, in this embodiment, the frame body 300 is provided with an opening 303 and an elongated groove 304. The elongated groove 304 is recessed on one surface of the frame body 300 facing away from the main gear 320 (referred to as a back surface 302 hereinafter) for accommodating the linear rack gear 310. The long axis direction of the elongated groove 304 is parallel to the vertical direction of the seat back 200 (e.g., the Y axis direction), that is, the elongated groove 304 extends towards the vertical direction of the seat back 200 (e.g., the Y axis direction). The opening 303 is connected to the elongated groove 304 so as to outwardly expose a part of the linear rack gear 310.

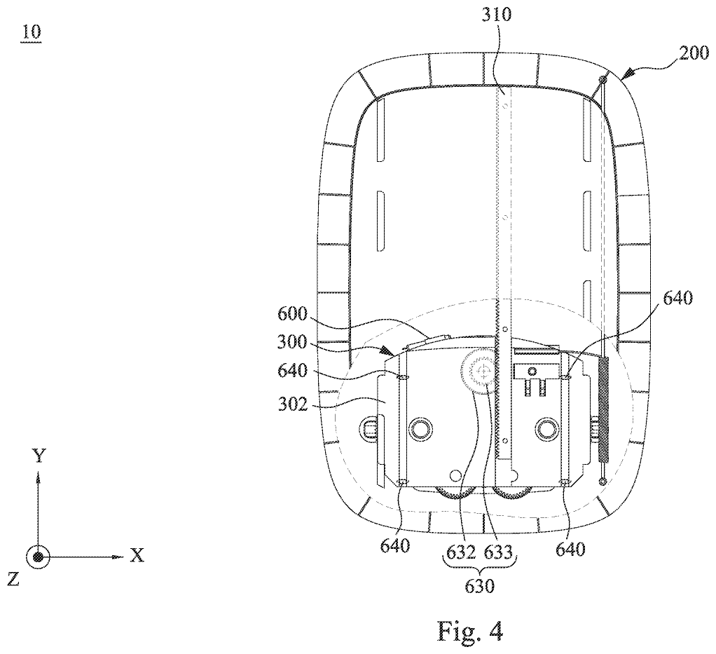

The back massaging device of claim 1 further includes two first speed-changing gears 530 and a second speed-changing gears 630. Each of the first speed-changing gears 530 is provided with a second rotation axis 531 that is parallel to the first rotation axis 322, and each of the first speed-changing gears 530 includes a first large gear 532 and a first small gear 533 which are superimposed on each other, and the first large gear 532 that is coaxially fixedly connected to the first small gear 533, and meshed with the first motor assembly 500. The first small gear 533 is meshed with one of the main gears 320. The second speed-changing gear 630 is provided with a third rotation axis 631 that is parallel to the first rotation axis 322. The second speed-changing gear 630 includes a second small gear 633 (FIG. 4), a second large gear 632 and a third small gear 634, which are superimposed on one another. The second large gear 632 is sandwiched between the second small gear 633 and the third small gear 634, and the second large gear 632 is coaxially fixedly connected to the second small gear 633 and third small gear 634, and the second large gear 632 is meshed with the second motor assembly 600, and the third small gear 634 is meshed with the second linkage gear 731 of the second detection module 730.

More specifically, the first motor assembly 500 includes a first motor main body 510 and a first threaded shaft 520. The first motor main body 510 is provided with a first transmission shaft 511 having a long axis direction (e.g., Y axis direction) that is orthogonal to the second rotation axis 531. The first threaded shaft 520 is coaxially sleeved on the first transmission shaft 511, sandwiched between the first speed-changing gears 530, and meshed with the first speed-changing gears, respectively. Thus, when the first motor main body 510 drives the first speed-changing gears 530 to be reversely rotated through the first threaded shaft 520, the first speed-changing gears 530 synchronously rotate the corresponding main gears 320 about the second rotation axis 531 respectively so as to drive the corresponding massage member 400. The second motor assembly 600 includes a second motor main body 610 and a second threaded shaft 620. The second motor main body 610 is provided with a second transmission shaft 611. The second threaded shaft 620 is coaxially sleeved on the second transmission shaft 611, and meshed with the second large gear 632 for rotating the second speed-changing gear 630 around the third rotation axis 631 so as to vertically move the frame body 300 up or down. Thus, when the second motor main body 610 drives the second speed-changing gears 630 to be rotated through the second threaded shaft 620, the second speed-changing gears 630 are synchronously rotated about the third rotation axis 631 to be vertically moved along the linear rack gear 310 so as to control a height position of the massage protrusion 420 in the vertical direction (e.g., Y axis direction).

FIG. 4 is a back view of the back massaging device 10 of FIG. 1 being seen through the back rest portion 220. As shown in FIG. 4, the back massaging device 10 includes a plurality of rollers 640 (e.g., four). The rollers 640 are spaced distributed on the back surface 302 of the frame body 300, and between the seat back 200 (i.e., an inner wall 211 of the accommodating recess 210) and the frame body 300. The rollers 640 are pivotally connected to the frame body 300 respectively and slidably contacted with the inner wall 211 of the accommodating recess 210 for the frame body 300 to be freely slidable on the seat back 200. For example, the rollers 640 are slidably engaged with rails located at the inner wall 211 of the accommodating recess 210. Thus, when the second motor assembly 600 drives the frame body 300 to vertically move, the frame body 300 can slide relatively along the linear rack gear 310 more smoothly by the rollers 640 slidably contacting with the inner wall 211 of the accommodating recess 210, thereby reducing the additional energy consumption of the second motor assembly 600 and increasing the product life of the frame body 300.

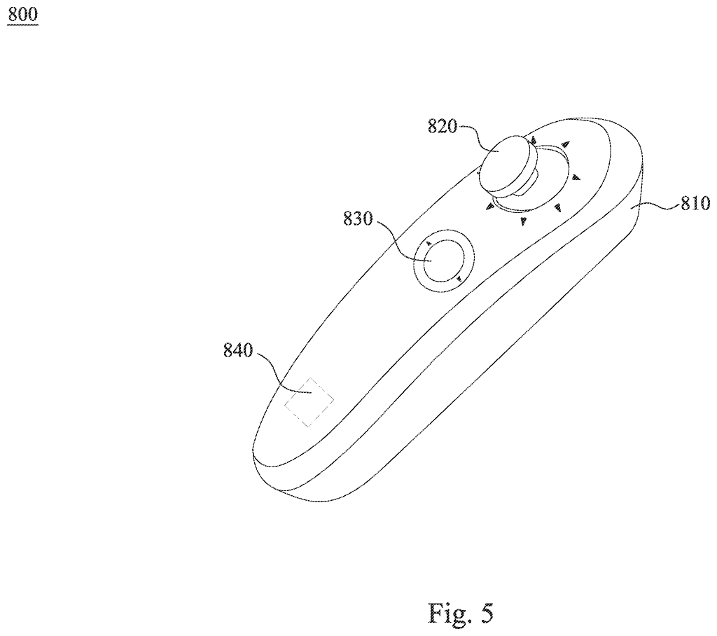

FIG. 5 is a front view of a manual control device 800 of a back massaging device 10 according to one embodiment of the present disclosure. As shown in FIG. 5, in another embodiment, the back massaging device 10 includes a manual control device 800. The manual control device 800 is disposed out of the seat back, wiredly or wirelessly connected to the seat back 200 to be electrically connected to the control unit 710 for manually controlling the back massaging device 10.

More specifically, the manual control device 800 is provided with a case 810 and an analog direction control interface 820. The analog direction control interface 820 is disposed on one surface of the case 810, and electrically connected to the control unit 710 so as to allow a user to fine-tune the massage protrusion 420 to shift in any direction during the trajectory pattern being continuously outlined by the massage protrusion 420. The analog direction control interface 820, for example is a universal joystick or a set of cross direction keys. Thus, when the back massaging device 10 is used, and when the analog direction control interface 820 is manipulated (or pressed) by the user, the analog direction control interface 820 can send out one of direction commands to the control unit 710, so that the control unit 710 can instantly drive the massage protrusion 420 to move according to the direction command during the trajectory pattern being continuously outlined by the massage protrusion 420.

In addition, the manual control device 800 further includes a massage-strength control interface 830. The massage-strength control interface 830 is disposed on the surface of the case 810, and electrically connected to the control unit 710. Thus, when the back massaging device 10 is used, and when the massage-strength control interface 830 is manipulated (or pressed) by the user so as to send out one of strength control commands to the control unit 710, the control unit 710 synchronously adjusts output voltages on the first motor assembly 500 for selectively controlling moving speed and/or massage strength of the massage protrusion 420 according to the strength control command.

More specifically, the control unit 710 adjusts and outputs at least one of kinds of voltages to the first motor assembly 500 continuously and intermittently, so as to exert different massage strengths by the massage protrusion at the same moving speed. For example, the control unit 710 continuously outputs a low-level voltage to the first motor assembly 500, so that the first motor assembly 500 makes the massage protrusions 420 to exert lower massage strength to the human body at the same speed; on the contrary, the first motor assembly 500 intermittently outputs a high-level voltage to the first motor assembly 500, for example, the first motor assembly 500 stands still for 0.5 seconds every 10 degrees of rotation, so that the first motor assembly 500 can exert greater massage strength to the human body through the massage protrusions 420 at the same speed.

In this way, in the same trajectory pattern, the first motor assembly 500 can exert greater massage strengths to the human body through the massage protrusions 420 by adjusting different voltages to the first motor assembly 500.

Also, the manual control device 800 includes a memory unit 840. The memory unit 840 is built within the case 810, and electrically connected to the control unit 710, and used to store the aforementioned trajectory scripts, the aforementioned direction commands and the aforementioned strength control commands. However, the disclosure is not limited thereto, in another embodiment, the memory unit 840 may not be located inside the manual control device 800, and the memory unit 840 is disposed on the frame body (e.g., the printed circuit board) and electrically connected to the control unit so as to store the aforementioned trajectory scripts, the aforementioned direction commands and the aforementioned strength control commands.

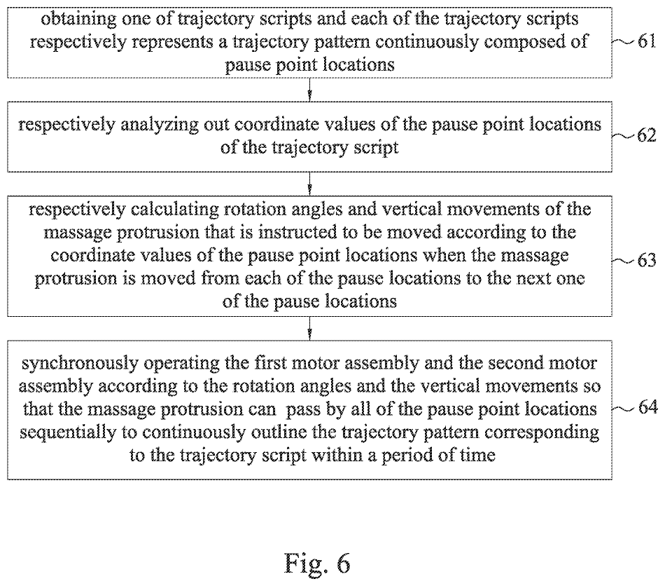

FIG. 6 is a flow chart of a controlling method of massage route according to one embodiment of the present disclosure. As shown in FIG. 2 and FIG. 6, in the embodiment, the controlling method of massage route is implemented to the aforementioned back massaging device 10, and the controlling method includes step 61 to step 64 as follows. In step 61, one of trajectory scripts is obtained and each of the trajectory scripts respectively represents a trajectory pattern continuously composed of pause point locations. In step 62, coordinate values of the pause point locations of the trajectory script are respectively analyzed out. In step 63, rotation angles and vertical movements of the massage protrusion 420 that is instructed to be moved are respectively calculated according to the coordinate values of the pause point locations when the massage protrusion 420 is moved from each of the pause locations to the next one of the pause locations. In step 64, the first motor assembly 500 and the second motor assembly 600 are controlled to operate synchronously according to the rotation angles and the vertical movements so that the massage protrusion 420 is allowed to pass by all of the pause point locations sequentially to continuously outline the trajectory pattern corresponding to the trajectory script within a period of time.

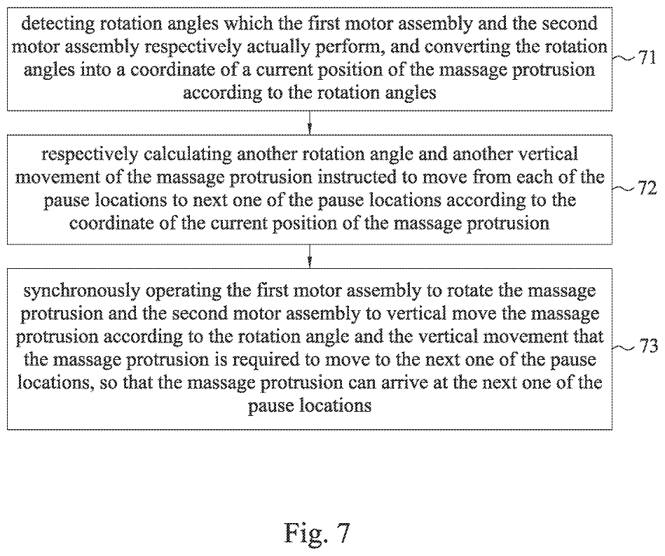

FIG. 7 is a detailed flow chart of step 64 in FIG. 6. As shown in FIG. 2 and FIG. 7, in the embodiment, when the massage protrusion 420 being moved from each of the pause locations to next one of the pause locations during the trajectory pattern being continuously outlined by the massage protrusion 420, the controlling method further includes step 71 to step 73 as follows. In step 71, rotation angles which the first motor assembly and the second motor assembly respectively actually perform are detected, and the rotation angles are converted into a coordinate of a current position of the massage protrusion according to the rotation angles. In step 72, another rotation angle and another vertical movement of the massage protrusion instructed to move from each of the pause locations to next one of the pause locations are respectively calculated according to the coordinate of the current position of the massage protrusion 420. In step 73, the first motor assembly is synchronously operated to rotate the massage protrusion 420 and the second motor assembly is synchronously operated to vertical move the massage protrusion 420 according to the rotation angle and the vertical movement that the massage protrusion 420 is required to move to the next one of the pause locations, so that the massage protrusion 420 can arrive at the next one of the pause locations, and back to step 71.

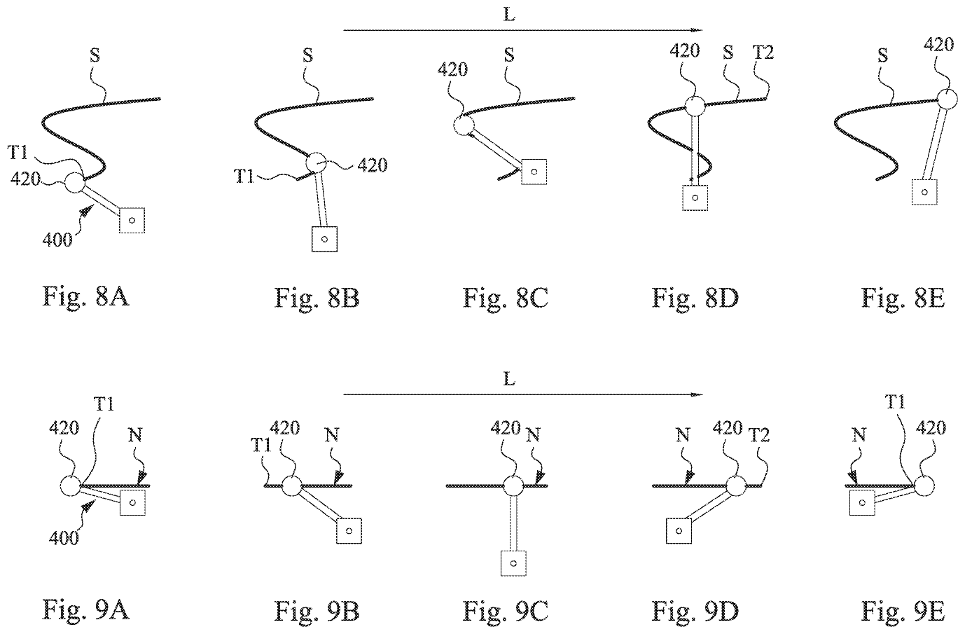

FIG. 8A to FIG. 8E are continual operational schematic views of a massage member 40 of FIG. 1 which has completed an S typed trajectory pattern S. As shown in FIG. 2 and FIG. 8A to FIG. 8E, for example, when one of the trajectory scripts begins to be executed by the back massaging device 10, and the executed trajectory script corresponds to an S-shaped trajectory pattern S, please observe from FIG. 8A to FIG. 8E along the direction sequence L. First, the control unit 710 activates the first motor assembly 500 and the second motor assembly 600 so that the massage protrusion 420 of the massage member 400 is moved to a starting point T1 of the S-shaped trajectory pattern S; then, as shown in FIG. 8B, the control unit 710 simultaneously performs the massage protrusion 420 to be vertically declined and rotated clockwise by a predetermined rotation angle so as to continue the executed trajectory script; then, as shown in FIG. 8C, the control unit 710 simultaneously performs the massage protrusion 420 to be vertically lifted and rotated counterclockwise by a predetermined rotation angle so as to continue the executed trajectory script; next, as shown in FIG. 8D, the control unit 710 simultaneously performs the massage protrusion 420 to be vertically declined and rotated clockwise by a predetermined rotation angle so as to continue the executed trajectory script; finally, as shown in FIG. 8E, the control unit 710 does not vertically lift the massage protrusion 420, but only rotates the massage protrusion 420 clockwise to an destination point T2 of the S-shaped trajectory pattern S.

FIG. 9A to FIG. 9E are continual operational schematic views of a massage member 400 of FIG. 1 which has completed a linear trajectory pattern N. As shown in FIG. 2 and FIG. 9A to FIG. 9E, for example, when one of the trajectory scripts begins to be executed by the back massaging device 10, and the executed trajectory script corresponds to a linear trajectory pattern N, please observe from FIG. 9A to FIG. 9E along the direction sequence L. First, the control unit 710 activates the first motor assembly 500 and the second motor assembly 600 so that the massage protrusion 420 of the massage member 400 is moved to a starting point T1 (i.e., the left end of the linear trajectory pattern N) of the linear trajectory pattern N; then, as shown in FIG. 9B, the control unit 710 simultaneously performs the massage protrusion 420 to be vertically declined and rotated clockwise by a predetermined rotation angle so as to continue the executed trajectory script; then, as shown in FIG. 9C, the control unit 710 simultaneously performs the massage protrusion 420 to be vertically declined and rotated clockwise by a predetermined rotation angle so that the long axis direction of the massage member 400 is parallel to the vertical direction (e.g., Y-axis direction) of the seat back 200, next, as shown in FIG. 9D, the control unit 710 simultaneously performs the massage protrusion 420 to be vertically lifted and rotated clockwise by a predetermined rotation angle so as to continue the executed trajectory script; finally, as shown in FIG. 9E, the control unit 710 simultaneously performs the massage protrusion 420 to be vertically lifted and rotated clockwise to an destination point T2 (i.e., the right end of the linear trajectory pattern N) of the linear trajectory pattern N.

It is noted, since the pause point locations of the linear trajectory pattern N which the above-mentioned massage protrusion 420 being stopped in order are at the same level, the trajectory pattern being continuously outlined by the massage protrusion 420 is a straight line that is orthogonal to the vertical direction (such as the Y-axis direction).

Thus, through the construction of the embodiments above, the present disclosure not only provides a highly flexible massage path, but also avoids monotonous and fixed trajectory patterns, and also allows to customize massage requirements.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims and their equivalents.

What is claimed is:

1. A back massaging device, comprising:
a seat back having a back rest portion for supporting a human back;
a linear rack gear fixedly disposed on the seat back and extending in a vertical direction of the seat back;
a frame body slidably disposed on the seat back;
a gear shaft having a first rotation axis passing through the back rest portion;
at least one main gear pivotally disposed at one surface of the frame body through the gear shaft;
a massage member comprising a support arm and a massage protrusion, the support arm that is fixedly connected to the massage protrusion and the gear shaft, and the massage protrusion that is deviated from the first rotation axis of the gear shaft;
a first motor assembly directly or indirectly meshed with the main gear for driving the main gear to rotate about the first rotation axis so as to rotate the massage protrusion by a predetermined angle;
a second motor assembly directly or indirectly meshed with the linear rack gear for driving the frame body to vertically move along the vertical direction so as to control a height position of the massage protrusion; and
a control unit disposed on the frame body, and electrically connected to the first motor assembly and the second motor assembly,
wherein when one of trajectory scripts is executed, the control unit sequentially calculates rotation angle values and vertical movements that the massage protrusion is instructed to be moved, and controls the first motor assembly and the second motor assembly to operate synchronously, so that the massage protrusion is allowed to outline a trajectory pattern corresponding to the one of the trajectory scripts.

2. The back massaging device of claim 1 further comprising:
a first detection module directly or indirectly meshed with the first motor assembly for detecting a first rotation angle which the first motor assembly actually performs;
a second detection module directly or indirectly meshed with the second motor assembly for detecting a second rotation angle which the second motor assembly actually performs; and
a conversion circuit electrically connected to the control unit, the first detection module and the second detection module,
wherein the control unit converts the first rotation angle and the second rotation angle into a coordinate of a current position of the massage protrusion.

3. The back massaging device of claim 2, wherein the first detection module comprises a first linkage gear and a first detecting element, the first linkage gear is rotatably disposed on the frame body, and directly meshed with the main gear, the first detecting element is disposed on the conversion circuit, and coupled with the first linkage gear for detecting the first rotation angle which the first linkage gear is actually rotated; and
the second detection module comprises a second linkage gear and a second detecting element, the second linkage gear is rotatably disposed on the frame body, and indirectly meshed with the second motor assembly, the second detecting element is disposed on the conversion circuit, and coupled with the second linkage gear for detecting the second rotation angle which the second linkage gear is actually rotated.

4. The back massaging device of claim 1 further comprising:
a first speed-changing gear comprising a large gear and a small gear which are superimposed on each other, the large gear that is coaxially fixedly connected to the small gear, and meshed with the first motor assembly, the small gear that is meshed with the main gear,
wherein the first speed-changing gear is provided with a second rotation axis that is parallel to the first rotation axis.

5. The back massaging device of claim 4, wherein the first motor assembly comprises:
a first motor main body provided with a first transmission shaft having a long axis direction that is orthogonal to the second rotation axis; and
a first threaded shaft coaxially sleeved on the first transmission shaft, and meshed with the first speed-changing gear for rotating the main gear around the second rotation axis through the first speed-changing gear.

6. The back massaging device of claim 1, further comprising:
a second speed-changing gear comprising a large gear and a small gear which are superimposed on each other, the large gear that is coaxially fixedly connected to the small gear, and meshed with the second motor assembly, the small gear that is meshed with the linear rack gear,
wherein the second speed-changing gear is provided with a third rotation axis that is parallel to the first rotation axis.

7. The back massaging device of claim 6, wherein the second motor assembly comprises:
a second motor main body provided with a second transmission shaft; and
a second threaded shaft coaxially sleeved on the second transmission shaft, and meshed with the large gear for rotating the second speed-changing gear around the third rotation axis to vertically move the frame body.

8. The back massaging device of claim 1, wherein the control unit is a pulse width modulation (PWM) controller.

9. The back massaging device of claim 1, further comprising:
a plurality of rollers spaced distributed on one surface of the frame body facing away from the main gear, arranged between the seat back and the frame body, and pivotally connected to the frame body respectively for the frame body to be slidable on the seat back.

10. The back massaging device of claim 1, further comprising:
a manual control device disposed out of the seat back, and electrically connected to the control unit, and provided with an analog direction control interface thereon,
wherein when the analog direction control interface is manipulated to send one of direction commands to the control unit during the trajectory pattern being continuously outlined by the massage protrusion, the control unit instantly drives the massage protrusion to move according to the one of the direction commands.

11. The back massaging device of claim 10, wherein the manual control device comprises:
a memory unit electrically connected to the control unit, and configured to store the trajectory scripts and the direction commands.

12. The back massaging device of claim 10, wherein the manual control device comprises:
a massage-strength control interface electrically connected to the control unit,
wherein when the massage-strength control interface is manipulated to send one of strength control commands to the control unit during the trajectory pattern being continuously outlined by the massage protrusion, the control unit synchronously adjusts output voltages on the first motor assembly for controlling at least one of moving speed and massage strength of the massage protrusion according to the one of strength control commands.

13. The back massaging device of claim 12, wherein the control unit adjusts and outputs at least one of kinds of voltages to the first motor assembly continuously and intermittently, so that the massage protrusion is allowed to exert different massage strengths at a same moving speed.

14. The back massaging device of claim 1, wherein the trajectory pattern continuously outlined by the massage protrusion is a straight line that is orthogonal to the vertical direction.

15. The back massaging device of claim 1, further comprising:
a memory unit disposed on the frame body, electrically connected to the control unit, and configured to store the trajectory scripts.

16. A controlling method of massage route that is implemented to the back massaging device of claim 1, the controlling method of massage route comprising:
obtaining one of trajectory scripts, wherein each of the trajectory scripts respectively represents a trajectory pattern continuously composed of pause point locations;
analyzing out coordinate values of the pause point locations of the one of the trajectory scripts, respectively;
respectively calculating out rotation angles and vertical movements of the massage protrusion instructed to be moved according to the coordinate values of the pause point locations when the massage protrusion is moved from each of the pause locations to the next one of the pause locations; and
controlling the first motor assembly and the second motor assembly to operate synchronously according to the rotation angles and the vertical movements so that the massage protrusion is allowed to pass by all of the pause point locations sequentially to continuously outline the trajectory pattern corresponding to the one of the trajectory scripts within a period of time.

17. The controlling method of claim 16, wherein the massage protrusion being moved from each of the pause locations to the next one of the pause locations during the trajectory pattern being continuously outlined by the massage protrusion, further comprises:
detecting rotation angles which the first motor assembly and the second motor assembly respectively actually perform, and converting the rotation angles into a coordinate of a current position of the massage protrusion according to the rotation angles;
respectively calculating another rotation angle and another vertical movement of the massage protrusion instructed to move from each of the pause locations to the next one of the pause locations according to the coordinate of the current position of the massage protrusion; and
synchronously operating the first motor assembly to rotate the massage protrusion and the second motor assembly to vertical move the massage protrusion according to the another rotation angle and the another vertical movement, so that the massage protrusion is arrived at the next one of the pause locations.

18. The controlling method of claim 16, wherein when one of direction commands is received during the trajectory pattern being continuously outlined within the period of time by the massage protrusion, the massage protrusion is instantly moved from the trajectory pattern according to the one of direction commands.

19. The controlling method of claim 16, wherein when one of strength control commands is received during the trajectory pattern being continuously outlined within the period of time by the massage protrusion, output voltages on the first motor assembly is synchronously adjusted according to the one of the strength control commands for controlling at least one of moving speed and massage strength of the massage protrusion.

20. The controlling method of claim 19, wherein the output voltages on the first motor assembly synchronously adjusted according to the one of the strength control commands further comprises:
adjusting at least one of kinds of voltages to the first motor assembly continuously and intermittently, so that the massage protrusion is allowed to exert different massage strengths at the same moving speed.
